(19) United States
(12) Patent Application Publication
(10) Pub. No.: US 2017/0196057 A1
(43) Pub. Date: Jul. 6, 2017

(54) LLC RESONANT CONVERTER

(71) Applicant: LG INNOTEK CO., LTD., Seoul (KR)

(72) Inventor: Jae Hyun HAN, Seoul (KR)

(21) Appl. No.: 15/389,657

(22) Filed: Dec. 23, 2016

(30) Foreign Application Priority Data
Dec. 30, 2015 (KR) 10-2015-0189969

(51) Int. Cl. H05B 33/08; H02M 7/217; H02M 1/42

(52) U.S. Cl. CPC H05B 33/0815; H02M 1/4241; H02M 7/217

(57) ABSTRACT

An LLC resonant converter includes a switching part including at least one switch configured to perform switching operation according to a switching control signal; a resonant tank circuit including a first coil and a capacitor, wherein LLC resonance having a plurality of resonant frequencies is formed in the resonant tank circuit according to the switching operation of the switching part; and a resonant controller configured to output the switching control signal to the switching part on the basis of an operating frequency of an input voltage.

### CROSS-REFERENCE TO RELATED APPLICATION

This application claims priority to and the benefit of Korean Patent Application No. 2015-0189969, filed on Dec. 30, 2015, the disclosure of which is incorporated herein by reference in its entirety.

### BACKGROUND

1. Field of the Invention

The present invention relates to an LLC resonant converter, and more particularly, to an LLC resonant converter having a plurality of resonant frequencies.

2. Description of Related Art

Recently, light emitting diode (LED) lighting has emerged as a promising market in a lighting industry in South Korea. Interest in LED lighting has significantly increased, as a way to save power in advanced countries as well as due to last year's large earthquake in Japan and the nuclear power plant accident in Fukushima. LED lighting companies in South Korea are actively achieving related certifications in every foreign country to preempt overseas markets, and there is a growing trend of introducing new LED lighting products to the market, which meet demands for LED lighting for replacing conventional fluorescent lamps and add sensibility and various functions that are difficult to be realized with conventional fluorescent lamps.

When a voltage applied to an LED is a threshold voltage of the LED or higher, current starts to flow in the LED so that light is emitted therefrom. Low-voltage direct current (DC) power is supplied to drive the LED using a battery, a power supply, or the like.

A power supply is mainly used as a device for supplying low-voltage DC power. The power supply receives commercial alternating current (AC) power, converts the AC power into a predetermined DC power, then converts the predetermined DC power into LED driving power, and supplies the LED driving power to an LED.

When an LED is driven by a conventional power supply, commercial AC power is converted into a predetermined DC power to drive the LED.

The converted DC power may be supplied to the LED using a half-bridge type LLC resonant converter for high output power and a step-down or boost converter using an output of the half-bridge type LLC resonant converter.

However, an operating frequency band increases proportionally to an output power range in order to cover a wide output power range in a DC/DC stage (LLC). Particularly, in a high switching frequency band, there is concern for damage due to switching loss of a field effect transistor (FET) and input/output efficiency of a converter is decreased. Further, 5 to 100% of an output current cannot be controlled. Although the output current can be controlled, there is a problem in that a driving range of the output voltage is narrow.

Therefore, a technology for high-output-power wide-range high-efficiency LED driver lighting circuit needs to be provided.

### SUMMARY OF THE INVENTION

The present invention is directed to providing an LLC resonant converter.

The technical objectives of the present invention are not limited to the above disclosure, and other objectives not described herein may become apparent to those of ordinary skill in the art on the basis of the following description.

According to an aspect of the present invention, there is provided an LLC resonant converter including a switching part including at least one switch configured to perform switching operation according to a switching control signal; a resonant tank circuit including a first coil and a capacitor, wherein LLC resonance having a plurality of resonant frequencies is formed in the resonant tank circuit according to the switching operation of the switching part; and a resonant controller configured to output the switching control signal to the switching part on the basis of an operating frequency of an input voltage.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a light emitting diode (LED) driver circuit including an LLC resonant converter according to one embodiment of the present invention;

FIG. 2 is a configuration diagram of the LLC resonant converter according to one embodiment of the present invention;

FIGS. 3 to 6 are views illustrating a first operation mode of the LLC resonant converter according to one embodiment of the present invention;

FIGS. 7 to 10 are views illustrating a second operation mode of the LLC resonant converter according to one embodiment of the present invention; and

FIG. 11 is a view illustrating resonant frequencies according to the first operation mode and the second operation mode of the LLC resonant converter according to one embodiment of the present invention.

### DETAILED DESCRIPTION OF EXEMPLARY EMBODIMENTS

Hereinafter, exemplary embodiments of the present invention will be described in detail with reference to the accompanying drawings. Advantages and features of the present invention and methods of accomplishing them will be made apparent with reference to the accompanying drawings and embodiments to be described below. The present invention may, however, be embodied in different forms and is not to be construed as being limited to the embodiments set forth herein. Rather, the embodiments are provided so that this disclosure is thorough and complete and fully conveys the inventive concept to those skilled in the art, and the present invention should only be defined by the appended claims. The same reference numerals indicate the same components throughout the specification.

Unless otherwise defined, all terms including technical and scientific terms used herein have the same meanings as commonly understood by one of ordinary skill in the art to which this present invention belongs. It should be further understood that terms such as those defined in commonly used dictionaries are not to be interpreted in an idealized or overly formal sense unless expressly so defined herein.

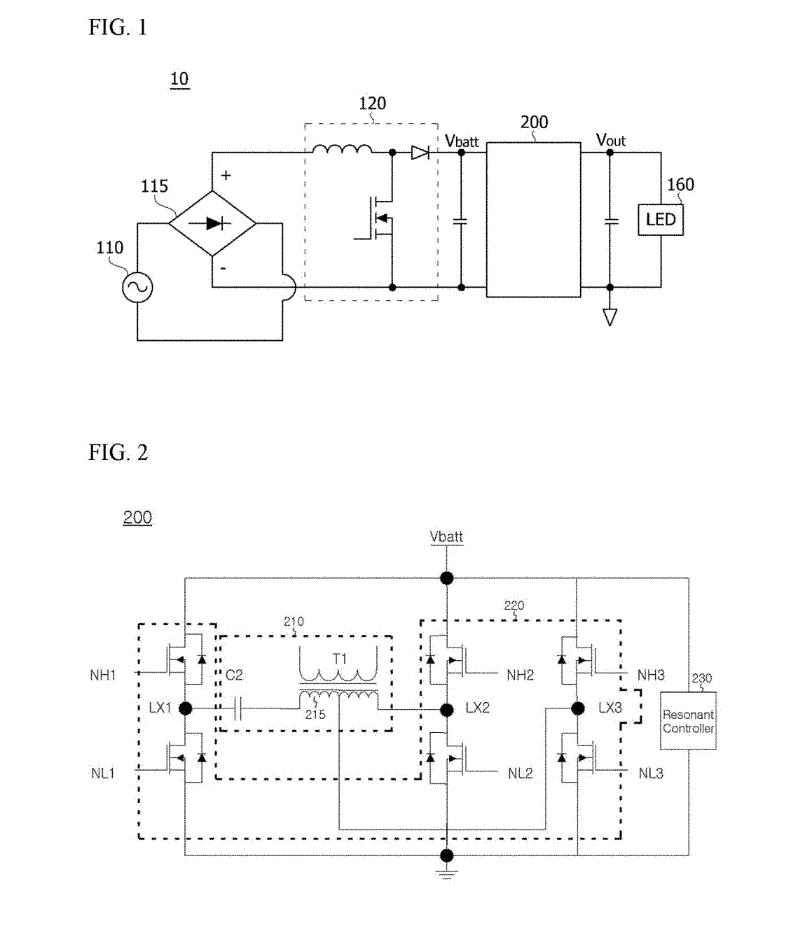

FIG. 1 is a light emitting diode (LED) driver circuit including an LLC resonant converter according to one embodiment of the present invention.

Referring to FIG. 1, an LED driver circuit 10 may include input power 110, a rectifier 115, a power factor corrector (PFC) 120, an LLC resonant converter 200, and an LED 160.

The input power 110 may be alternating current (AC) power to be supplied for operating LED driver circuit 10.

The rectifier 115 is a circuit which converts the AC power into direct current (DC) power. The rectifier 115 may include a bridge circuit.

The PFC 120 improves a power factor of power and may include a boost circuit which boosts a voltage. For example, a voltage of 100 V to 200 V of the input power 110 passes through the PFC 120 so that a voltage of 400 V may be output.

The LLC resonant converter 200 is a double full bridge type converter which receives an output of the PFC 120. The LLC resonant converter 200 may adjust a resonant frequency by adding a switching element at a first coil side and changing an inductance value at the first coil side using only a part of the first coil. Accordingly, since the resonant frequency is adjusted according to an input voltage, high efficiency output power may be supplied for a wide operating frequency band.

The LED 160 may include a buck or boost circuit which receives an output of the LLC resonant converter 200 and drives a plurality of LED channels.

FIG. 2 is a configuration diagram of the LLC resonant converter according to one embodiment of the present invention.

Referring to FIG. 2, the LLC resonant converter 200 according to one embodiment of the present invention may include a resonant tank circuit 210, a switching part 220, and a resonant controller 230

The resonant tank circuit 210 includes a first coil 215 and a capacitor C2, and inductor-inductor-capacitor (LLC) resonance is formed therein. One end of the first coil 215 is connected to a switch included in the switching part 220, and the other end, which is different from the one end, is connected to the capacitor C2. A switch included in the switching part 220 may be connected to a node between both ends of the first coil 215. One end of the capacitor C2 is connected to a switch included in the switching part 220, and the other end, which is different from the one end, is connected to the first coil 215.

Since the switch included in the switching part 220 is connected to the node between both ends of the first coil 215, only a part of the first coil 215 in the resonant tank circuit 210 may be used for LLC resonance according to a switching operation of the switch. When a part of the first coil 215 is used for the LLC resonance, an inductance value of the first coil 215 participating in the LLC resonance may be changed. Since a resonant frequency is changed according to the inductance value of the first coil 215, the LLC resonant converter 200 may be an LLC resonant converter having a plurality of resonant frequencies.

The switching part 220 may include at least one switch which performs switching operation according to an input switching control signal. The switching part 220 may include a first main switch NH1 and a first auxiliary switch NL1 connected to one end of the first coil 215, a second main switch NH2 and a second auxiliary switch NL2 connected to one end of the capacitor C2, and a third main switch NH3 and a third auxiliary switch NL3 connected to a node between both ends of the first coil 215.

One end of each of the first main switch NH1, the second main switch NH2, and the third main switch NH3 may be connected to a voltage input terminal Vbatt of the LLC resonant converter 200. One end of each of the first auxiliary switch NL1, the second auxiliary switch NL2, and the third auxiliary switch NL3 may be connected to a ground.

The other end of each of the first main switch NH1 and the first auxiliary switch NL1 may be connected to a first contact node LX1. The other end of each of the second main switch NH2 and the second auxiliary switch NL2 may be connected to a second contact node LX2. The other end of each of the third main switch NH3 and the third auxiliary switch NL3 may be connected to a third contact node LX3.

One end of the capacitor C2 may be connected to the first contact node LX1. One end of the first coil 215 may be connected to the second contact node LX2. The node between both ends of the first coil 215 may be connected to the third contact node LX3.

Referring to FIG. 2, although the first main switch NH1, the second main switch NH2, the third main switch NH3, the first auxiliary switch NL1, the second auxiliary switch NL2, and the third auxiliary switch NL3 are illustrated as N-type metal-oxide semiconductor field-effect-transistors (nMOSFETs), the nMOSFETs are merely examples, and the present invention is not limited thereto.

The resonant controller 230 may output a switching control signal to the switching part 220 on the basis of an operating frequency of an input voltage.

When the operating frequency is lower than a reference frequency defined in advance, the resonant controller 230 may operate in a first operation mode. In the first operation mode, the resonant controller 230 maintains turned-off states of the third main switch NH3 and the third auxiliary switch NL3, and may output a switching control signal which turns on or off each of the first main switch NH1, the first auxiliary switch NL1, the second main switch NH2, and the second auxiliary switch NL2.

When the operating frequency is higher than the reference frequency, the resonant controller 230 may operate in a second operation mode. In the second operation mode, the resonant controller 230 maintains turned-off states of the second main switch NH2 and the second auxiliary switch NL2, and may output a switching control signal which turns on or off each of the first main switch NH1, the first auxiliary switch NL1, the third main switch NH3, and the third auxiliary switch NL3.

Since the second main switch NH2 and the second auxiliary switch NL2 are connected to the one end of the first coil 215 and the third main switch NH3 and the third auxiliary switch NL3 are connected to the node between both ends of the first coil 215, an inductance value of the first coil is reduced in the second operation mode compared to the first operation mode so that a value of the resonant frequency is further increased, and thus the second operation mode may be operated in an operating frequency band higher than that of the first operation mode.

Although connections between the resonant controller 230 and the first main switch NH1, the second main switch NH2, the third main switch NH3, the first auxiliary switch NL1, the second auxiliary switch NL2, and the third auxiliary switch NL3 are not illustrated in FIGS. 2 to 10 for convenience of descriptions, this omission is merely for increasing readability, and signal lines may be connected between the resonant controller 230 and each switch included in the switching part 220. The resonant controller 230 may output a switching control signal to each switch included in the switching part 220 using the signal lines.

The switching control signal may include a turn-on signal or a turn-off signal. Switching of the switch, which received the turn-on signal, turns on, and switching of the switch, which received the turn-off signal, turns off.

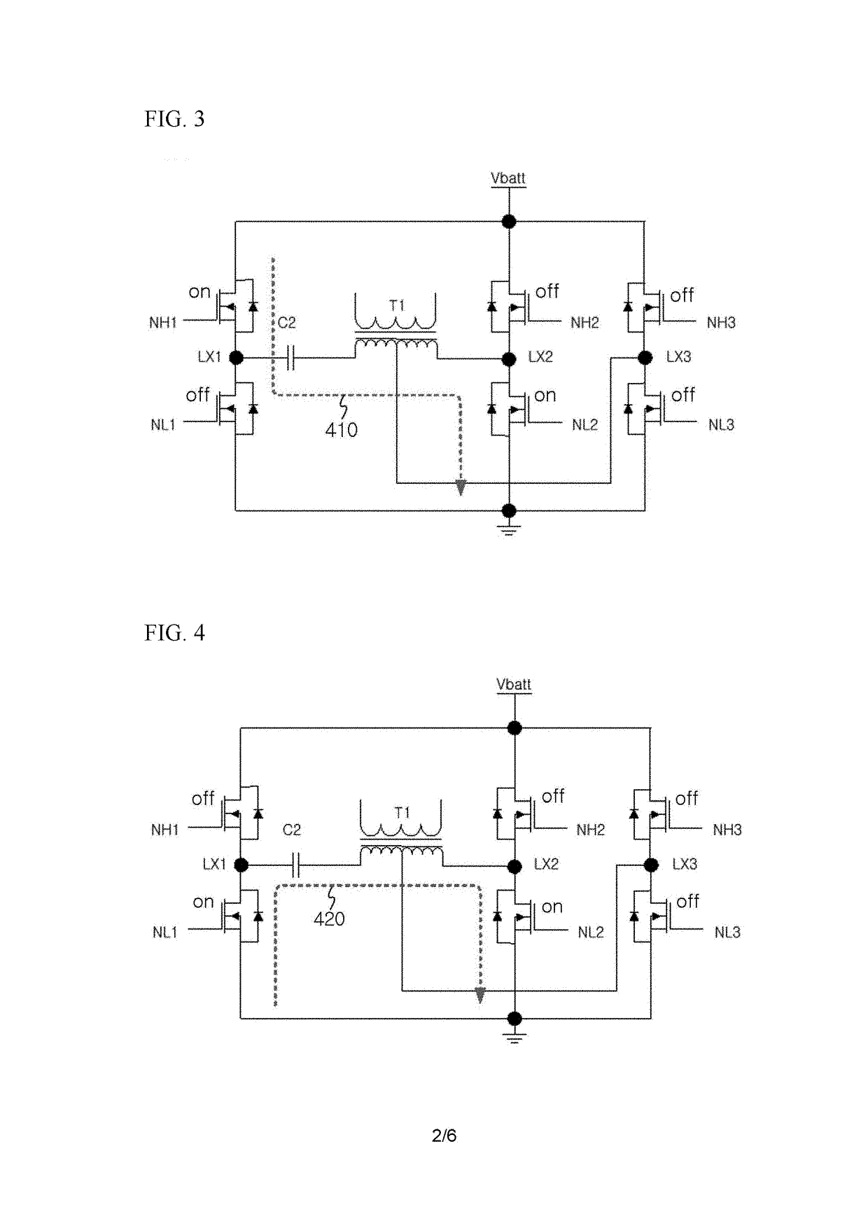

FIGS. 3 to 6 are views illustrating a first operation mode of the LLC resonant converter according to one embodiment of the present invention.

Since the resonant controller 230 continuously outputs a turn-off signal to the third main switch NH3 and the third auxiliary switch NL3 in the first operation mode, turned-off states of the third main switch NH3 and the third auxiliary switch NL3 may be maintained.

First, referring to FIG. 3, the resonant controller 230 outputs the switching control signal which turns on the first main switch NH1, turns off the first auxiliary switch NL1, turns off the second main switch NH2, and turns on the second auxiliary switch NL2. Thus, a current 410 input from a voltage input terminal Vbatt flows to a ground via the first main switch NH1, the resonant tank circuit 210, and the second auxiliary switch NL2.

Then, referring to FIG. 4, the resonant controller 230 outputs the switching control signal which turns off the first main switch NH1, turns on the first auxiliary switch NL1, turns off the second main switch NH2, and turns on the second auxiliary switch NL2. Thus, a residual current 420 in the resonant tank circuit 210 flows to a ground so that zero voltage switching (ZVS) is formed and a constant delay time is generated.

Then, referring to FIG. 5, the resonant controller 230 outputs the switching control signal which turns off the first main switch NH1, turns on the first auxiliary switch NL1, turns on the second main switch NH2, and turns off the second auxiliary switch NL2. Thus, a current 430 of a voltage input terminal Vbatt passes through the second main switch NH2 and flows in a direction opposite the first coil of the resonant tank circuit 210. The current 430 flows to a ground via the resonant tank circuit 210 and the first auxiliary switch NL1.

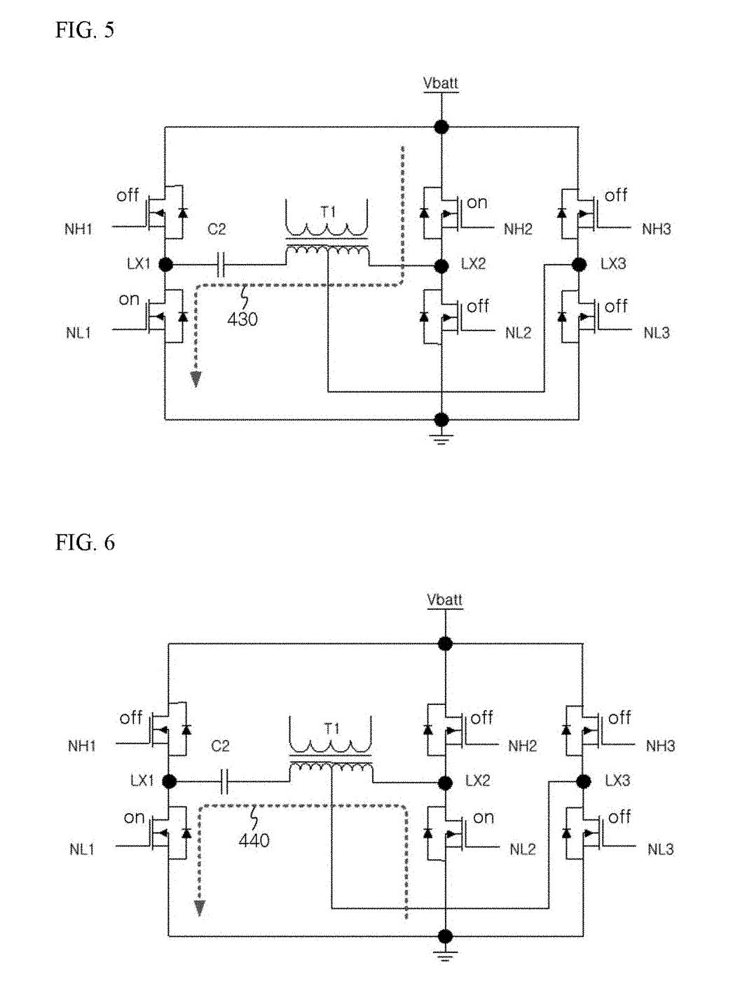

Then, referring to FIG. 6, the resonant controller 230 outputs the switching control signal which turns off the first main switch NH1, turns on the first auxiliary switch NL1, turns off the second main switch NH2, and turns on the second auxiliary switch NL2. Thus, a residual current 440 of the resonant tank circuit 210 flows to a ground via the first auxiliary switch NL1. At this point, ZVS is formed again, and a delay time is generated.

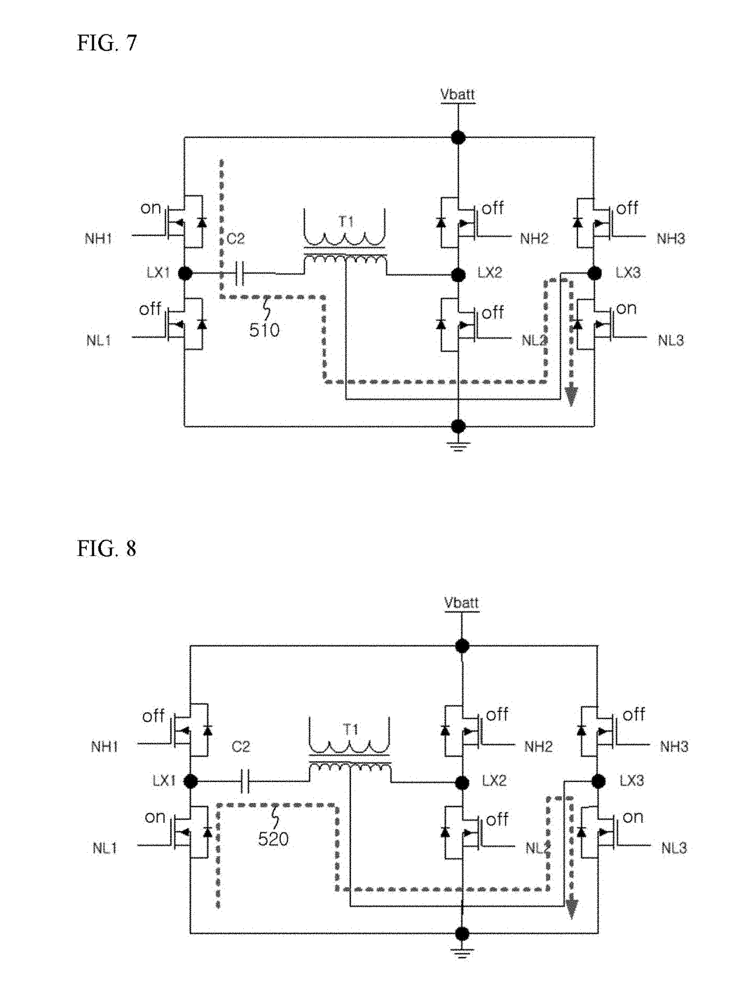

FIGS. 7 to 10 are views illustrating a second operation mode of the LLC resonant converter according to one embodiment of the present invention.

When conditions defined in advance are satisfied, the resonant controller 230 may output a switching control signal to the switching part 220 to operate in the second operation mode. Although decreasing an input voltage or increasing an operating frequency of the input voltage may be included in the conditions, this is merely examples, and the present invention is not limited thereto.

In one embodiment of the present invention, when the operating frequency of the input voltage is increased to a reference frequency defined in advance or higher, the resonant controller 230 may operate in the second operation mode.

Referring to FIGS. 7 to 10, when it is assumed that an operating frequency of a voltage input to a voltage input terminal Vbatt is the reference frequency or higher, a process of outputting a switching control signal to the switching part 220 using the resonant controller 230 which operates in the second operation mode will be described step by step.

Since the resonant controller 230 continuously outputs a turn-off signal to the second main switch NH2 and the second auxiliary switch NL2 in the second operation mode, turned-off states of the second main switch NH2 and the second auxiliary switch NL2 are maintained.

First, referring to FIG. 7, the resonant controller 230 outputs the switching control signal which turns on the first main switch NH1, turns off the first auxiliary switch NL1, turns off the third main switch NH3, and turns on the third auxiliary switch NL3. Thus, a current 510 of the voltage input terminal Vbatt flows to a ground via the first main switch NH1, the resonant tank circuit 210, and the third auxiliary switch NL3. Since the current 510 flows to only a node connected to the first main switch NH1 and a node connected to the third auxiliary switch NL3 in the first coil 215, only a part of the first coil 215 forms resonance, and a first inductance value participating for the resonance is reduced. Hereinafter, in FIGS. 8 to 10, a current flows in only the part.

Then, referring to FIG. 8, the resonant controller 230 outputs the switching control signal which turns off the first main switch NH1, turns on the first auxiliary switch NL1, turns off the third main switch NH3, and turns on the third auxiliary switch NL3. Thus, a residual current 520 of the resonant tank circuit 210 flows to a ground, ZVS is formed, and a constant delay time is generated.

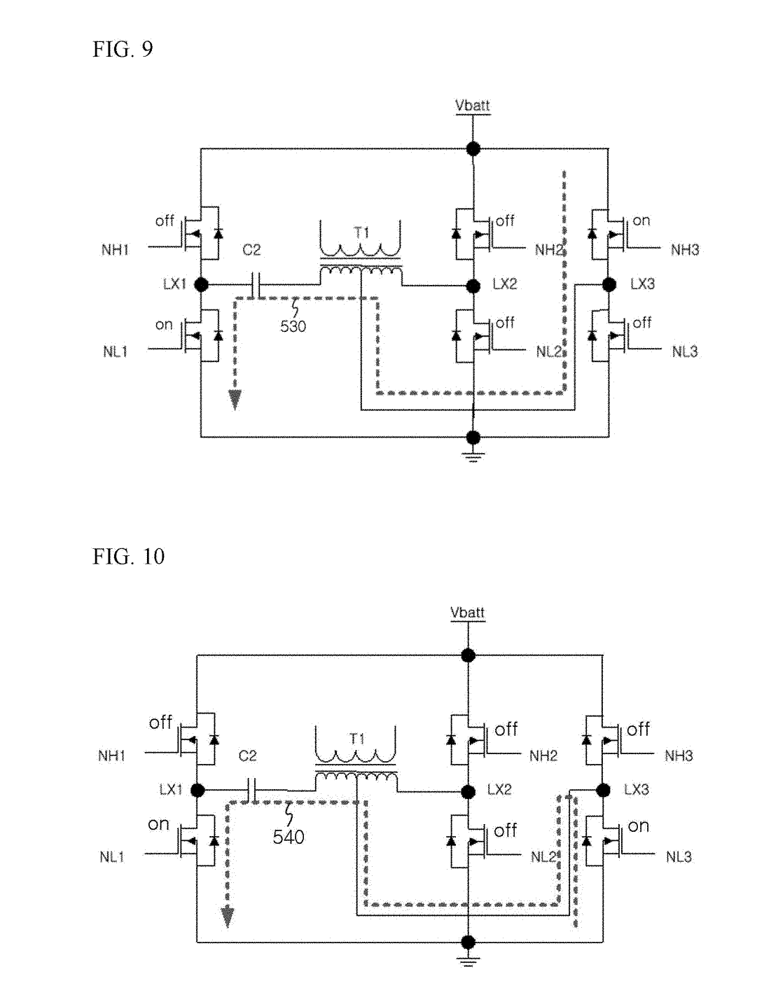

Then, referring to FIG. 9, the resonant controller 230 outputs the switching control signal which turns off the first main switch NH1, turns on the first auxiliary switch NL1, turns on the third main switch NH3, and turns off the third auxiliary switch NL3. Thus, a current 530 of a voltage input terminal Vbatt passes through the third main switch NH3 and flows in a direction opposite the first coil of the resonant tank circuit 210. The current 530 flows to a ground via the resonant tank circuit 210 and the first auxiliary switch NL1.

Then, referring to FIG. 10, the resonant controller 230 outputs the switching control signal which turns off the first main switch NH1, turns on the first auxiliary switch NL1, turns off the third main switch NH3, and turns on the third auxiliary switch NL3. Thus, a residual current 540 of the resonant tank circuit 210 flows to a ground via the first auxiliary switch NL1. At this point, ZVS is formed again, and a delay time is generated.

As shown in FIGS. 7 to 10, since only a part of the first coil 215 forms resonance in the second operation mode, a first inductance value is decreased, and a resonant frequency is increased compared to in the first operation mode. When conditions defined in advance, in which a resonant frequency needs to be increased, are satisfied, the resonant controller 230 may output the switching control signal to the switching part 220 to operate in the second operation mode.

Therefore, the LLC resonant converter 200 according to one embodiment of the present invention may change a resonant frequency according to an input voltage and thus may operate with higher efficiency.

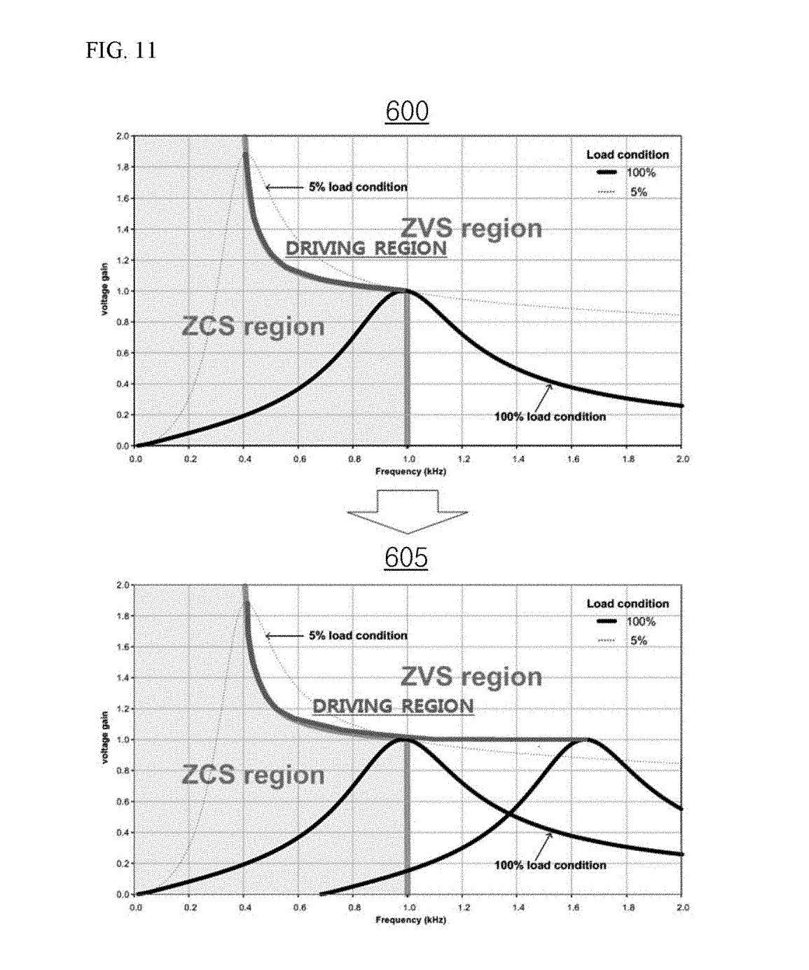

FIG. 11 is a view illustrating resonant frequencies according to the first operation mode and the second operation mode of the LLC resonant converter according to one embodiment of the present invention.

Referring to FIG. 11, a frequency response graph 600 of a conventional LLC resonant converter has only one resonant frequency, but it is apparent that a frequency response graph 605 of the LLC resonant converter 200 according to one embodiment of the present invention has two resonant frequencies.

According to the embodiments of the present invention, since the LLC resonant converter can have a plurality of resonant frequencies using switching control, the LLC resonant converter can be driven with maximum efficiency according to an input voltage.

Embodiments of the present invention have been described above with reference to the accompanying drawings. Those skilled in the art should understand that the present invention may be implemented in other forms different from the disclosed embodiments without modifying the technical spirit or essential features of the disclosure. Therefore, the above described embodiments should be considered in a descriptive sense only and not for the purpose of limitation.

What is claimed is:

1. An LLC resonant converter comprising:
a switching part including at least one switch configured to perform switching operation according to a switching control signal,
a resonant tank circuit including a first coil and a capacitor, wherein LLC resonance having a plurality of resonant frequencies is formed in the resonant tank circuit according to the switching operation of the switching part; and
a resonant controller configured to output the switching control signal to the switching part on the basis of an operating frequency of an input voltage.

2. The LLC resonant converter of claim 1, wherein the LLC resonant tank circuit has the plurality of resonant frequencies because only a part of the first coil is used for the LLC resonance by the switching operation of the switching part.

3. The LLC resonant converter of claim 1, wherein the switching part includes:
a first main switch and a first auxiliary switch which are connected to one end of the first coil;
a second main switch and a second auxiliary switch which are connected to the other end, which is different from the one end of the first coil; and
a third main switch and a third auxiliary switch which are connected to a node between the one end and the other end of the first coil.

4. The LLC resonant converter of claim 1, wherein, when the operating frequency is lower than a reference frequency defined in advance, the resonant controller maintains turned-off states of the third main switch and the third auxiliary switch and outputs the switching control signal which turns on or off the first main switch, the first auxiliary switch, the second main switch, or the second auxiliary switch.

5. The LLC resonant converter of claim 4, wherein the resonant controller outputs the switching control signal, which turns on the first main switch, turns off the first auxiliary switch, turns off the second main switch, and turns on the second auxiliary switch, and outputs the switching control signal which turns off the first main switch, turns on the first auxiliary switch, turns off the second main switch, and turns on the second auxiliary switch so that a delay time due to zero voltage switching (ZVS) is generated, and then outputs the switching control signal, which turns off the first main switch, turns on the first auxiliary switch, turns on the second main switch, and turns off the second auxiliary switch, and outputs the switching control signal which turns off the first main switch, turns on the first auxiliary switch, turns off the second main switch, and turns on the second auxiliary switch so that a delay time due to ZVS is generated.

6. The LLC resonant converter of claim 1, wherein, when the operating frequency is higher than a reference frequency defined in advance, the resonant controller maintains turned-off states of the second main switch and the second auxiliary switch and outputs the switching control signal which turns on or off the first main switch, the first auxiliary switch, the third main switch, or the third auxiliary switch.

7. The LLC resonant converter of claim 6, wherein the resonant controller outputs the switching control signal, which turns on the first main switch, turns off the first auxiliary switch, turns off the third main switch, and turns on the third auxiliary switch, and outputs the switching control signal which turns off the first main switch, turns on the first auxiliary switch, turns off the third main switch, and turns on the third auxiliary switch so that a delay time due to zero voltage switching (ZVS) is generated, and then outputs the switching control signal, which turns off the first main switch, turns on the first auxiliary switch, turns on the third main switch, and turns off the third auxiliary switch, and outputs the switching control signal which turns off the first main switch, turns on the first auxiliary switch, turns off the third main switch, and turns on the third auxiliary switch so that a delay time due to ZVS is generated.

8. A light emitting diode (LED) driver circuit connected to an LED and configured to control driving of the LED, the LED driver circuit comprising:
an input power terminal to which alternating current (AC) power is applied;
a rectifier configured to convert the AC power into direct current (DC) power;
a boost circuit configured to boost a voltage of the converted DC power; and
an LLC resonant converter which decreases the boosted power to a driving voltage of the LED selectively using one of a plurality of resonant frequencies and supplies the decreased power to the LED.

9. The LED driver circuit of claim 8, wherein the LLC resonant converter includes:
a switching part including at least one switch configured to perform switching operation according to a switching control signal;
a resonant tank circuit including a first coil and a capacitor, wherein LLC resonance having the plurality of resonant frequencies is formed in the resonant tank circuit according to the switching operation of the switching part; and
a resonant controller configured to output the switching control signal to the switching part on the basis of an operating frequency of an input voltage.

10. The LED driver circuit of claim 9, wherein the resonant controller outputs the switching control signal, which causes the entire first coil of the resonant tank circuit to be used, to the switching part when the operating frequency of the input voltage is lower than a reference frequency defined in advance, and outputs the switching control signal, which causes only a part of the first coil of the resonant tank circuit to be used, to the switching part when the operating frequency of the input voltage is higher than the reference frequency defined in advance.
